(19) United States
(12) Patent Application Publication
(10) Pub. No.: US 2026/0204163 A1
(43) Pub. Date: Jul. 16, 2026

(54) HUMAN-MACHINE INTEGRATED VESSEL CONTROL METHOD BASED ON SHARED PANEL

(71) Applicant: SOUTHEAST UNIVERSITY, Jiangsu (CN)

(72) Inventors: Xinde LI, Jiangsu (CN); Zhentong ZHANG, Jiangsu (CN); Guoliang WU, Jiangsu (CN)

(73) Assignee: SOUTHEAST UNIVERSITY, Jiangsu (CN)

(21) Appl. No.: 19/558,497

(22) Filed: Mar. 6, 2026

Related U.S. Application Data
(63) Continuation of application No. PCT/CN2025/118671, filed on Sep. 3, 2025.

(30) Foreign Application Priority Data
Dec. 23, 2024 (CN) 202411902362.X

(51) Int. Cl. G08G 3/00; B63B 49/00; B63B 79/15; B63B 79/40; G05B 13/02

(52) U.S. Cl. CPC G08G 3/00; B63B 49/00; B63B 79/15; B63B 79/40; G05B 13/027

(57) ABSTRACT

A human-machine integrated vessel control method based on a shared panel includes the following steps: acquiring multi-source sensor data using multi-source sensors by friendly vessels, fusing the multi-source sensor data to obtain fused data, calculating future trajectories of the enemy target vessels using a temporal neural network; sharing the encrypted fused data with the friendly fleet, and receiving encrypted fused data from other shared panels synchronously; determining planned routes and intents of the friendly vessels after obtaining the encrypted fused data and sharing planned route and intent of the friendly vessels; and modifying a trajectory or a combat objective of a friendly vessel by a human commander, and re-optimizing planned paths by other friendly vessels based on the intent of the friendly vessel, intent of the enemy target vessels, and mission objectives on the shared panel, and sharing the re-optimized paths, thereby completing human-machine integrated vessel control in real time.

### CROSS-REFERENCE TO RELATED APPLICATION

This application is a continuation of international application of PCT application serial no. PCT/CN2025/118671 filed on Sep. 3, 2025, which claims the priority benefit of China application no. 202411902362.X filed on Dec. 23, 2024. The entirety of each of the above-mentioned patent applications is hereby incorporated by reference herein and made a part of this specification.

### TECHNICAL FIELD

The present disclosure belongs to the technical field of human-machine interaction and information collaboration, and in particular to a human-machine integrated vessel control method based on a shared panel.

### BACKGROUND

In maritime law enforcement and rights-protection missions, when facing massive volumes of data and complex maneuvering schemes, fleets require accurate and consistent full-range situational awareness display, real-time and user-friendly course plotting, and collaborative global task awareness with low perception load. Therefore, enhancing the perception capability and coordination of maritime law-enforcement and rights-protection fleets through systematic and intelligent technologies has significant practical application value.

In existing maritime law enforcement and rights protection missions, perception methods based on a single entity are unable to achieve large-scale global situational awareness, resulting in poor patrol and maneuvering capability and low operational efficiency. Multi-entity perception systems lack effective methods for consistent data fusion, making them difficult to rapidly obtain accurate and reliable unified awareness results from complex and massive perception data.

Information among individual fleet units is isolated and poorly shared. Therefore, the fleet cannot share planned paths and operational intentions of other units in real time, making the fleet units impossible to ensure coordination and cooperation for the same mission. In addition, path planning and control are separated from human-machine interaction, resulting in poor interaction and a tendency for path deviation in complex situations.

### SUMMARY

Objective of the present disclosure: the present disclosure aims to provide a human-machine integrated vessel control method based on a shared panel.

Technical solution: The human-machine integrated vessel control method based on a shared panel provided in the present disclosure includes a friendly fleet, which includes a plurality of friendly vessels, and each friendly vessel is provided with a shared panel. The method specifically includes the following steps:
step 1: acquiring multi-source sensor data using multi-source sensors by the friendly vessels in the fleet, where the multi-source sensor data include information of the friendly vessels, information of enemy target vessels, and surrounding environmental information;
step 2. fusing the multi-source sensor data acquired by different friendly vessels to obtain fused data, calculating future trajectories of the enemy target vessels using a temporal neural network f, and determining a tactical mode of the enemy target vessels based on the future trajectories;
step 3. encrypting and compressing the fused data to obtain encrypted fused data, sharing the encrypted fused data with other shared panels in the friendly fleet, and receiving encrypted fused data from other shared panels synchronously;
step 4. decrypting the encrypted fused data by the friendly vessel to obtain decrypted fused data after receiving the same, determining planned routes and intents of the other friendly vessels based on the decrypted fused data and mission objectives, and sharing planned route and intent of the friendly vessels via the shared panel; and
step 5. modifying a trajectory or a combat objective of the friendly vessel by drawing a trajectory map on the shared panel by a human commander, and re-optimizing planned paths by other friendly vessels based on the intent of the friendly vessel, intent of the target vessel, and mission objectives on the shared panel, and sharing the re-optimized paths, thereby completing human-machine integrated vessel control in real time.

Further, the information of the friendly vessels includes position, heading, and velocity of the friendly vessel. The information of the enemy target vessels includes target vessel detection, attribute recognition, target vessel tracking, as well as positioning, velocity, acceleration, and heading of the target vessels. The target vessel detection, attribute recognition, and target vessel tracking are achieved through a camera, and the surrounding environmental information, and the positioning, velocity, acceleration, and heading of the target vessels are achieved by a radar.

Further, the target vessel detection includes the following steps:
step 21. acquiring image data of the vessels using the camera, and dividing the acquired image data into a training set and a test set for training using transfer learning; and
step 22. identifying a class of the target vessels using a deep learning-based target detection algorithm, assigning a unique identifier to each detected target vessel, and retrieving the information of corresponding vessel class from a vessel class database to display the information on the shared panel.

The specific detection process is expressed by the following equations:

$$( {P}_{i 1} , {P}_{i 2} , … , {P}_{ij} ) = g ( Network output )$$

$$( {x}_{i} , {y}_{i} , {w}_{i} , {h}_{i} ) = f ( Network output )$$

where P_{i,j} denotes the probability assignment that an i^{th} bounding box belongs to a j^{th} vessel class; xᵢ, yᵢ, wᵢ, hᵢ denote center coordinates, width, and height of a vessel, respectively; and g and f are decoding heads of a neural network. A unique identifier is assigned to each detected target vessel, and initial position, velocity and other information of the target vessels are obtained. An extended Kalman filter is used to perform trajectory tracking of the target vessel, and tracking results are output to the shared panel.

Further, the target vessel tracking is expressed by the following equation:

$${\hat{x}}_{k \vert k} = {\hat{x}}_{k \vert k - 1} + {K}_{k} ( {Z}_{k} - h ( {\hat{x}}_{k \vert k - 1} ) )$$

where \hat{x}_{k|k} is an optimal estimate of the target at current time, \hat{x}_{k|k-1} is a predicted estimate of the target at the current time, Zₖ is an observation value, h(\hat{x}_{k|k-1}) is an observation function, and Kₖ is a Kalman gain.

Further, in the step 2, the multi-source sensor data acquired by different friendly vessels are fused using a Dempster-Shafer (D-S) evidence theory to obtain fused data, which is expressed by the following equation:

$${m}_{12 … n} ( A ) = \frac{{\sum }_{{B}_{1} ∩ {B}_{2} ∩ … ∩ {B}_{n} = A} {m}_{1} ( {B}_{1} ) \cdot {m}_{2} ( {B}_{2} ) \cdot … \cdot {m}_{n} ( {B}_{n} )}{1 - {\sum }_{{B}_{1} ∩ {B}_{2} ∩ … ∩ {B}_{n} = ∅} {m}_{1} ( {B}_{1} ) \cdot {m}_{2} ( {B}_{2} ) \cdot … \cdot {m}_{n} ( {B}_{n} )}$$

where m_{12 . . . n}(A) denotes a combined probability assignment obtained from the results of n friendly vessels, mₙ denotes a basic probability assignment corresponding to results of an n^{th} friendly vessel as an evidence source, A denotes final fused results of the friendly vessels, and Bₙ denotes an event set supported by sensor observation results of the n^{th} friendly vessel.

Further, in the step 2, the fused data include information, trajectories, and intents of all friendly vessels, information and trajectories of the enemy target vessels, and the surrounding environmental information.

Further, the future trajectories Y of the enemy target vessels are expressed by the following equation:

$$Y = f ( X , θ )$$

where Y denotes the future trajectories of the target vessels, X=[x₁, x₂, . . . , xₙ] denotes a feature vector of the target vessels, f denotes a temporal neural network, and θ denotes network parameters.

Input consists of features of the target vessels, including position, velocity, acceleration, vessel class, and historical data mining patterns, forming a feature vector X=[x₁, x₂, . . . , xₙ]. Output consists of estimated position information Y of the target vessel within a period of time in the future. After the predicted trajectories of the enemy target vessels are obtained, an expert system based on historical big data is established to determine a tactical mode (such as attack, retreat, breakout, decoy, or reconnaissance) of the target vessels corresponding to the trajectories.

Further, in the step 3, the planned routes of the other friendly vessels are expressed by the following equation:

$$∇ J ( θ ) = {E}_{( {s}_{t} , {a}_{t} ) ∼ {π}_{θ}} [ \frac{{π}_{θ} ( {a}_{t} \vert {s}_{t} )}{{π}_{{θ}^{′}} ( {a}_{t} \vert {s}_{t} )} {A}^{{θ}^{′}} ( {s}_{t} , {a}_{t} ) ∇ log {π}_{θ} ( {a}_{t} \vert {s}_{t} ) ]$$

where ∇J(θ) denotes a gradient of a policy θ, E₍ₛ_{ₜ}_{,a}_{ₜ}_{)~π}_{_{θ}} denotes an expected value of sampled trajectories, sₜ denotes a state at time t, aₜ denotes an action at the time t, the subscript t denotes time, θ denotes a policy parameter, π denotes a policy function, and A denotes an advantage function.

A reinforcement learning model based on the Proximal Policy Optimization (PPO) algorithm may be constructed. The shared panel is gridded based on the current situational state of the shared panel, and the strategy is formulated using the situational information on the shared panel, target intent, and mission objectives. A gradient ascent method is applied for optimization, and the computed planning steps are used as tactical paths for the vessels. The situational information on the shared panel includes timestamps; state information, path planning information, and intents of all friendly vessels; information and intents of all vessels in a target fleet; overall maritime operational environment information; and overall mission information of the friendly vessels.

Further, in the step 5, after the initial planning is completed, the vessel's maneuvering route may be modified through hand-drawing. The planned routes or modified drawing data are recorded and shared on the shared panel, and are distinguished by different colors according to different vessel sources. Once the navigation route of a vessel is modified, all other vessels can obtain the updated information via the shared panel.

Hand-drawn trajectory maps are recognized using an online recognition method, and position points and velocity during trajectory drawing are recorded. Aline element is identified to determine whether a drawn element is a straight line element, a curve element, or a circular arc element. After determining the type of line element, points on the line element are subjected to straight-line fitting, polyline fitting, or circular arc fitting.

Further, the straight-line fitting is performed using a least squares method, which is expressed by the following equation:

$${σ}_{1}^{2} = {\sum }_{i = 1}^{n} {( {y}_{i} - A {x}_{i} - B )}^{2}$$

where α₁² denotes an error, xᵢ and yᵢ denote the horizontal and vertical coordinates of the i-th point on the hand-drawn trajectory map, respectively. A and B denote parameters of a straight-line fitting equation;
the polyline fitting is performed by calculating intersection point coordinates, which is expressed by the following equations:

$$x = \frac{{c}_{1} {a}_{2} - {c}_{2} {a}_{1}}{{a}_{1} {b}_{2} - {a}_{2} {b}_{1}}$$

$$y = \frac{{c}_{2} {b}_{1} - {c}_{1} {b}_{2}}{{a}_{1} {b}_{2} - {a}_{2} {b}_{1}}$$

where x and y denote coordinates of a polyline intersection point, a₁, b₁ and c₁ denote parameters of a first linear equation, and a₂, b₂ and c₂ denote parameters of a second linear equation.

The circular arc fitting is performed using the least squares method, which is expressed by the following equation:

$${σ}_{2}^{2} = {\sum }_{j = 1}^{n} {( \sqrt{{( {x}_{j} - X )}^{2} + {( {y}_{j} - Y )}^{2}} - R )}^{2}$$

where σ₂ denotes an error, xⱼ and yⱼ denote the horizontal and vertical coordinates of the i^{th} point on the hand-drawn trajectory map, respectively. R denotes a radius of the circular arc, and X and Y denote coordinates of a center point of the circular arc.

### BRIEF DESCRIPTION OF THE DRAWINGS

FIG. 1 is a schematic flowchart of a human-machine integrated vessel control method based on a shared panel.

FIG. 2 is a schematic diagram illustrating display effect of a shared panel.

FIG. 3 is a schematic diagram illustrating an interaction and coordination logic among a human commander, a shared panel, vessels, and a fleet.

### DETAILED DESCRIPTIONS OF THE EMBODIMENTS

### Embodiment 1

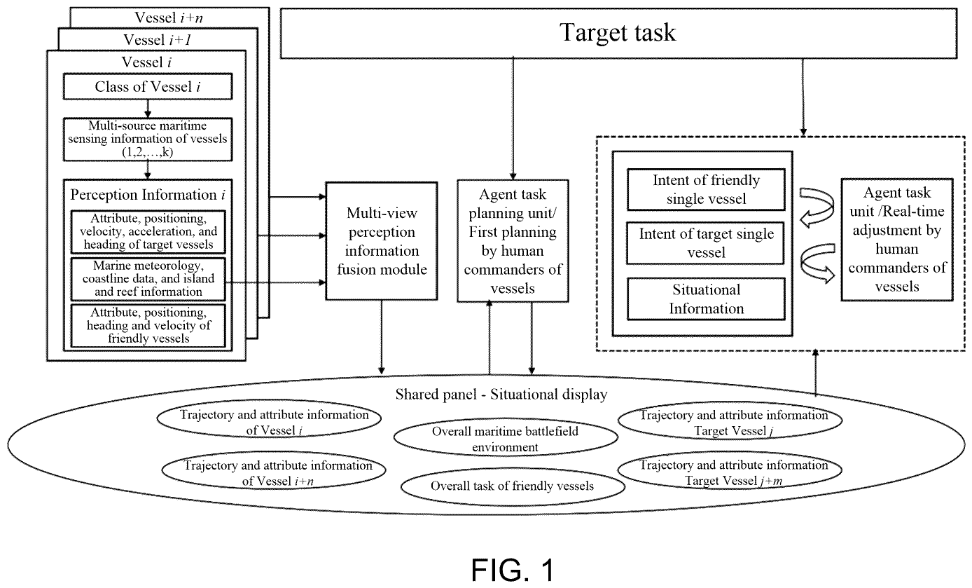

As shown in FIG. 1, the present disclosure provides a human-machine integrated vessel control method based on a shared panel, including the following steps:

Step S1: acquiring sensor data of each vessel in a fleet, where a Global Positioning System (GPS) is configured to determine positions of friendly vessels, an Inertial Measurement Unit (IMU) is configured to calculate velocities, accelerations, and headings of the friendly vessels; camera data are used to perform detection, attribute recognition, and tracking of a target vessel; radar data are used to detect a surrounding maritime environment and determine position, velocity acceleration, and heading of the target vessel; and wind sensors and meteorological station information are used to detect changes in the maritime environment.

Multi-source sensor data are received in real time, and camera and radar information collected by individual vessels include different perspective information of a same perception region shared with other vessels.

A camera is configured to acquire image data of the target vessel, and the image data are then divided into a training set and a test set for training using transfer learning. A deep learning-based target detection algorithm is employed to identify common maritime vessel classes, the identified vessel classes are linked to a vessel class database, from which corresponding vessel attributes, equipment, and other information are retrieved and displayed on a shared panel. P_{i,j} denotes the probability assignment that an i^{th} bounding box belongs to j^{th} vessel class; xᵢ, yᵢ, wᵢ, hᵢ denote center coordinates, width, and height of a vessel, respectively; and g and f are decoding heads of a neural network. The detection process is expressed as:

$$( {P}_{i 1} , {P}_{i 2} , … , {P}_{ij} ) = g ( Network output )$$

$$( {x}_{i} , {y}_{i} , {w}_{i} , {h}_{i} ) = f ( Network output )$$

A unique identifier is assigned to each detected target vessel, and initial position, velocity and other information of the target vessel are obtained. An extended Kalman filter is used to perform trajectory tracking of the target vessel, and tracking results are output to the shared panel. Let \hat{x}_{k|k} be an optimal estimate of the target at current time, \hat{x}_{k|k-1} be a predicted estimate of the target at the current time, Zₖ be an observation value, h(\hat{x}_{k|k-1}) be an observation function, and Kₖ be a Kalman gain. The tracking equation is expressed as follows:

$${\hat{x}}_{k \vert k} = {\hat{x}}_{k \vert k - 1} + {K}_{k} ( {Z}_{k} - h ( {\hat{x}}_{k \vert k - 1} ) )$$

Step S2: fusing perception results of the same target from different vessels after obtaining perception results from individual vessels, where for basic information of the friendly vessels, including position, velocity, and class, results from the vessel itself are taken as authoritative. For perception information of the target vessel, since camera, position, velocity, class and other information collected by different vessels may vary, uncertain information from different sources is fused using a Dempster-Shafer (D-S) evidence theory, thereby providing decision-level fusion results. Assuming that the results from n friendly vessels serve as evidence sources, with corresponding basic probability assignment of mₙ, the combined probability assignment is calculated according to the following equation:

$${m}_{12 … n} ( A ) = \frac{{\sum }_{{B}_{1} ∩ {B}_{2} ∩ … ∩ {B}_{n} = A} {m}_{1} ( {B}_{1} ) \cdot {m}_{2} ( {B}_{2} ) \cdot … \cdot {m}_{n} ( {B}_{n} )}{1 - {\sum }_{{B}_{1} ∩ {B}_{2} ∩ … ∩ {B}_{n} = ∅} {m}_{1} ( {B}_{1} ) \cdot {m}_{2} ( {B}_{2} ) \cdot … \cdot {m}_{n} ( {B}_{n} )} .$$

Multi-source sensor data are processed using intelligent perception algorithms to identify position, category, heading, velocity, acceleration, and other information. Processing includes both current perception information and prior information from historical data. Multi-source information fusion algorithms are used to align perception information of a same target from multiple vessels, and eliminate feature ambiguity, ensuring that the fleet maintains consistent perception of the same target within a unified coordinate system at the same time.

Step S3: performing data encryption and compression. The data are encrypted using RSA technology, and a pulse code modulation method is used for near-lossless real-time compression of a data stream. Data sharing and synchronous reception are achieved through offshore 5G networks and edge cloud technology. The shared panel displays perception results obtained from multi-source sensor fusion, including: information, trajectories, and intents of all friendly vessels; information and trajectories of detectable enemy target vessels, and overall environmental information. Future trajectories of each enemy target vessels are calculated using a temporal neural network f. Input consists of features of the target vessels, including position, velocity, acceleration, vessel class, and historical data mining patterns, forming a feature vector X=[x₁, x₂, . . . , xₙ]. Output consists of estimated position information Y of the target vessel within a period of time in the future, which may be expressed as follows:

$$Y = f ( X , θ )$$

where θ denotes network parameters

After the predicted trajectories of the enemy target vessels are obtained, an expert system based on historical big data is established to determine a tactical mode (such as attack, retreat, breakout, decoy, or reconnaissance) of the target vessels corresponding to the trajectories. A commander or intelligent algorithm can formulate a strategy for the friendly fleet based on target trajectories and tactics.

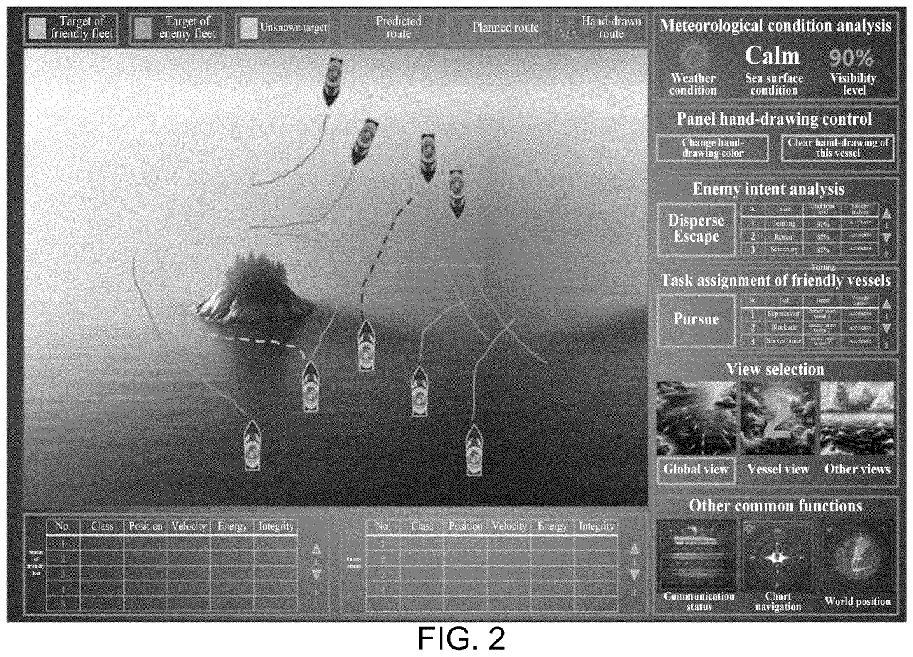

The display effect of shared panel is shown in FIG. 2, and includes analysis of maritime meteorological conditions, attributes, states, trajectories, predictions and intent analysis of the target vessel; attributes, states, trajectories, predictions, and intent of the friendly vessels, overall mission objectives; viewpoint switching; and hand-drawn route conversion and display functions.

Step S4: Based on the situational information obtained in the previous step and combined with mission objectives, future trajectories and tactical intent of friendly vessels by a human commander can define through hand-drawing on the shared panel, thereby facilitating tactical coordination among other vessels. When no specific commands are issued, a reinforcement learning model based on the Proximal Policy Optimization (PPO) algorithm may be constructed. The shared panel is gridded based on the current situational state of the shared panel, and the strategy is formulated using the situational information on the shared panel, target intent, and mission objectives. A gradient ascent method is applied for optimization, and the computed planning steps are used as tactical paths for the vessels.

$$∇ J ( θ ) = {E}_{( {s}_{t} , {a}_{t} ) ∼ {π}_{θ}} [ \frac{{π}_{θ} ( {a}_{t} \vert {s}_{t} )}{{π}_{{θ}^{′}} ( {a}_{t} \vert {s}_{t} )} {A}^{{θ}^{′}} ( {s}_{t} , {a}_{t} ) ∇ log {π}_{θ} ( {a}_{t} \vert {s}_{t} ) ]$$

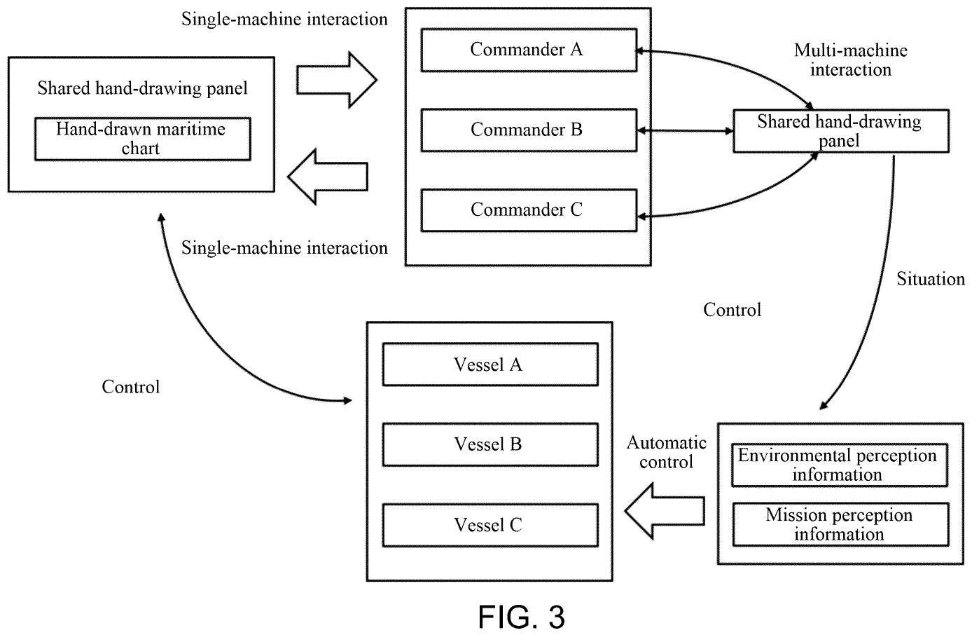

The interaction and coordination logic among the human commander, the shared panel, individual vessels, and the fleet are illustrated in FIG. 3. The commander can control a navigation state of the friendly vessel through a local interface on the shared panel, achieving automatic control either by drawing a route map or by selecting mission intent. During the control process, such information is uploaded in real time to a shared hand-drawing panel. After acquiring the uploaded information, other vessels adjust their respective strategies accordingly, with options for an automatic adjustment mode or a manual adjustment mode.

Step S5: after an initial planning, the commander may modify the vessel's action route through hand-drawing, share the route planning or modify the drawn data on the shared panel, which are distinguished using different colors according to different vessel sources. Once the commander modifies the navigation route of a vessel, all other vessels can acquire the updated information via the shared panel.

Hand-drawn trajectory maps are recognized using an online recognition method, and position points and velocity during trajectory drawing are recorded. Aline element is identified to determine whether a drawn element is a straight line element, a curve element, or a circular arc element. After determining the type of line element, points on the line element are subjected to straight-line fitting, polyline fitting, or circular arc fitting. When the line element is fitted as a straight line, a least squares method is employed to fit a straight-line equation, which is expressed as follows:

$${σ}^{2} = {\sum }_{i = 1}^{n} {( {y}_{i} - A {x}_{i} - B )}^{2}$$

where σ² denotes an error, xᵢ and yᵢ denote the horizontal and vertical coordinates of the i-th point on the hand-drawn trajectory map, respectively. A and B denote parameters of a straight-line fitting equation;

The polyline is fitted by calculating intersection point coordinates. The intersection point coordinates are obtained by solving two linear equations simultaneously, thereby correcting the hand-drawn trajectory results.

$$x = \frac{{c}_{1} {a}_{2} - {c}_{2} {a}_{1}}{{a}_{1} {b}_{2} - {a}_{2} {b}_{1}}$$

$$y = \frac{{c}_{2} {b}_{1} - {c}_{1} {b}_{2}}{{a}_{1} {b}_{2} - {a}_{2} {b}_{1}}$$

When a fitting error of a straight-line model exceeds a predefined threshold, the least squares method is employed to fit a circular arc element, which may be expressed as follows:

$${σ}_{2}^{2} = {\sum }_{j = 1}^{n} {( \sqrt{{( {x}_{j} - X )}^{2} + {( {y}_{j} - Y )}^{2}} - R )}^{2}$$

where σ₂² denotes an error, xⱼ and yⱼ denote the horizontal and vertical coordinates of the i^{th} point on the hand-drawn trajectory map, respectively. R denotes a radius of the circular arc, and X and Y denote coordinates of a center point of the circular arc.

Step S6: At regular intervals, the shared panel performs information synchronization to detect modified vessel trajectories or mission information. When no information has been modified, all vessel paths are updated once again.

When information has been modified, and a vessel selected for manual control does not change its trajectory, the remaining automatically controlled vessels output cooperative actions using reinforcement learning. Compared with the initially determined vessel trajectory, the input additionally includes the current and future trajectories of the other friendly vessels, as well as the previously planned trajectory of the friendly vessel. Accordingly, the next output action of an automatic vessel is selected according to the following equation:

$$a = arg {max}_{a ∈ A} π ( a \vert s ) ←$$

where a denotes an action, s denotes a current state, A denotes an action space, and π(a|s) denotes a policy function representing a probability of selecting action a under state s.

Autonomous vessel paths are updated. In order to avoid conflicts between algorithm-generated paths and commander-planned paths, commands of the commander are taken as a top priority, and the remaining autonomously controlled vessels perform automatic coordination. The human commander may switch control modes as needed.

Step S7: After calculating the planned path for subsequent tasks of the friendly vessel, the path is re-uploaded to the shared panel for coordination by other vessels or for further modification of the planned routes, thereby realizing an iterative update function.

Beneficial effects: Compared with the prior art, the present disclosure has the following significant advantages: The human-machine integrated vessel control method based on a shared panel provided by the present disclosure adopts multi-source information fusion theory and interaction technology based on the shared panel, and simultaneously solves the problems of incomplete information acquisition from a single vessel, poor accuracy of perception results under complex multi-source information, and lack of information sharing, poor interaction and coordination among vessels in a fleet during mission execution.

What is claimed is:

1. A human-machine integrated vessel control method based on a shared panel, wherein a friendly fleet comprises a plurality of friendly vessels, and each friendly vessel is provided with the shared panel; and the method comprises the following steps:
step 1: acquiring multi-source sensor data using multi-source sensors by the friendly vessels in the fleet, wherein the multi-source sensor data comprise information of the friendly vessels, information of enemy target vessels, and surrounding environmental information;
step 2. fusing the multi-source sensor data acquired by different friendly vessels to obtain fused data, calculating future trajectories of the enemy target vessels using a temporal neural network f, and determining a tactical mode of the enemy target vessels in the trajectories after obtaining the future trajectories of the enemy target vessels;
step 3. encrypting and compressing the fused data to obtain encrypted fused data, sharing the encrypted fused data with other shared panels in the friendly fleet, and receiving the encrypted fused data from the other shared panels synchronously;
step 4. decrypting the encrypted fused data by the friendly vessel to obtain decrypted fused data after receiving the same, determining planned routes and intents of the other friendly vessels based on the decrypted fused data and mission objectives, and sharing planned route and intent of the friendly vessels via the shared panel; and
step 5. modifying a trajectory or a combat objective of the friendly vessel by drawing a trajectory map on the shared panel by a human commander, and re-optimizing planned paths by the other friendly vessels based on the intent of the friendly vessel, intent of the enemy target vessels, and mission objectives on the shared panel, and sharing the re-optimized paths, thereby completing the human-machine integrated vessel control in real time.

2. The human-machine integrated vessel control method based on the shared panel according to claim 1, wherein the information of the friendly vessels comprises position, heading, and velocity of the friendly vessel, and the information of the enemy target vessels comprises target vessel detection, attribute recognition, target vessel tracking, as well as positioning, velocity, acceleration, and heading of the target vessels; and the target vessel detection, attribute recognition, and the target vessel tracking are achieved through a camera, and the surrounding environmental information, and the positioning, the velocity, the acceleration, and the heading of the target vessels are achieved by a radar.

3. The human-machine integrated vessel control method based on the shared panel according to claim 2, wherein the target vessel detection comprises the following steps:
step 21. acquiring image data of all vessels using the camera, and dividing the acquired image data into a training set and a test set for training using transfer learning; and
step 22. identifying a class of the target vessels using a deep learning-based target detection algorithm, assigning a unique identifier to each detected target vessel, and retrieving the information of corresponding vessel class from a vessel class database to display the information on the shared panel.

4. The human-machine integrated vessel control method based on the shared panel according to claim 2, wherein the target vessel tracking is expressed by the following equation:
$${\hat{x}}_{k \vert k} = {\hat{x}}_{k \vert k - 1} + {K}_{k} ( {Z}_{k} - h ( {\hat{x}}_{k \vert k - 1} ) )$$
wherein \hat{x}_{k|k} is an optimal estimate of the target at current time, \hat{x}_{k|k-1} is a predicted estimate of the target at the current time, Zₖ is an observation value, h(\hat{x}_{k|k-1}) is an observation function, and Kₖ is a Kalman gain.

5. The human-machine integrated vessel control method based on the shared panel according to claim 1, wherein in the step 2, the multi-source sensor data acquired by different friendly vessels are fused using a Dempster-Shafer (D-S) evidence theory to obtain the fused data, which is expressed by the following equation:
$${m}_{12 … n} ( A ) = \frac{{\sum }_{{B}_{1} ∩ {B}_{2} ∩ … ∩ {B}_{n} = A} {m}_{1} ( {B}_{1} ) \cdot {m}_{2} ( {B}_{2} ) \cdot … \cdot {m}_{n} ( {B}_{n} )}{1 - {\sum }_{{B}_{1} ∩ {B}_{2} ∩ … ∩ {B}_{n} = ∅} {m}_{1} ( {B}_{1} ) \cdot {m}_{2} ( {B}_{2} ) \cdot … \cdot {m}_{n} ( {B}_{n} )}$$
wherein m_{12 . . . n}(A) denotes a combined probability assignment obtained from the results of n friendly vessels, mₙ denotes a basic probability assignment corresponding to results of an n^{th} friendly vessel as an evidence source, A denotes final fused results of the friendly vessels, and Bₙ denotes an event set supported by sensor observation results of the n^{th} friendly vessel.

6. The human-machine integrated vessel control method based on the shared panel according to claim 1, wherein in the step 2, the fused data comprise information, trajectories, and intents of all friendly vessels, information and trajectories of the enemy target vessels, and the surrounding environmental information.

7. The human-machine integrated vessel control method based on the shared panel according to claim 6, wherein the future trajectories Y of the enemy target vessels are expressed by the following equation:
$$Y = f ( X , θ )$$
wherein Y denotes the future trajectories of the target vessels, X=[x₁, x₂, . . . , xₙ] denotes a feature vector of the target vessels, f denotes the temporal neural network, and θ denotes network parameters.

8. The human-machine integrated vessel control method based on the shared panel according to claim 1, wherein in the step 4, the planned routes of the other friendly vessels are expressed by the following equation:
$$∇ J ( θ ) = {E}_{( {s}_{t} , {a}_{t} ) ∼ {π}_{θ}} [ \frac{{π}_{θ} ( {a}_{t} \vert {s}_{t} )}{{π}_{{θ}^{′}} ( {a}_{t} \vert {s}_{t} )} {A}^{{θ}^{′}} ( {s}_{t} , {a}_{t} ) ∇ log {π}_{θ} ( {a}_{t} \vert {s}_{t} ) ]$$
wherein ∇J(θ) denotes a gradient of a policy θ, E₍ₛ_{ₜ}_{,a}_{ₜ}_{)~π}_{_{θ}} denotes an expected value of sampled trajectories, sₜ denotes a state at time t, aₜ denotes an action at the time t, subscript t denotes time, θ denotes a policy parameter, π denotes a policy function, and A denotes an advantage function.

9. The human-machine integrated vessel control method based on the shared panel according to claim 1, wherein in the step 5, hand-drawn trajectory maps are recognized using an online recognition method, position points and velocity during trajectory drawing are recorded, and a type of line element is determined; and the type of line element comprises a straight line element, a curve element, and a circular arc element, and the straight line element, the curve element, or the circular arc element are respectively fitted using straight-line fitting, polyline fitting, and circular arc fitting based on points on the line element.

10. The human-machine integrated vessel control method based on the shared panel according to claim 9, wherein the straight-line fitting is performed using a least squares method, which is expressed by the following equation:
$${σ}_{1}^{2} = {\sum }_{i = 1}^{n} {( {y}_{i} - A {x}_{i} - B )}^{2}$$
wherein σ₁ denotes an error, xᵢ and yᵢ denote x-coordinate and y-coordinate of an i^{th} coordinate point on the hand-drawn trajectory map, n denotes a number of coordinate points on the hand-drawn trajectory map, and A and B denote parameters of a straight-line fitting equation;
the polyline fitting is performed by calculating intersection point coordinates, which is expressed by the following equations:
$$x = \frac{{c}_{1} {a}_{2} - {c}_{2} {a}_{1}}{{a}_{1} {b}_{2} - {a}_{2} {b}_{1}}$$
$$y = \frac{{c}_{2} {b}_{1} - {c}_{1} {b}_{2}}{{a}_{1} {b}_{2} - {a}_{2} {b}_{1}}$$
wherein (x,y) denote coordinates of a polyline intersection point, a₁, b₁ and c₁ denote parameters of a first linear equation, and a₂, b₂ and c₂ denote parameters of a second linear equation; and
the circular arc fitting is performed using the least squares method, which is expressed by the following equation:
$${σ}_{2} = {\sum }_{j = 1}^{n} ( \sqrt{{( {x}_{j} - X )}^{2} + {( {y}_{j} - Y )}^{2}} - R )$$
wherein σ₂ denotes an error, xⱼ and yⱼ denote x-coordinate and y-coordinate of a j^{th} coordinate point on the hand-drawn trajectory map, R denote a radius of the circular arc, and X and Y denote coordinates of a center point of the circular arc.
